(19) United States
(12) Patent Application Publication
(10) Pub. No.: US 2004/0193463 A1
(43) Pub. Date: Sep. 30, 2004

(54) Method and system to improve the performance of the sales process in paper machine business

(76) Inventor: Juha Linja, Helsinki (FI)

Correspondence Address: STIENNON & STIENNON, 612 W. MAIN ST., SUITE 201, P.O. BOX 1667, MADISON, WI, 53701-1667, US

(21) Appl. No.: 10/802,266

(22) Filed: Mar. 17, 2004

Related U.S. Application Data
(60) Provisional application No. 60/455,726, filed on Mar. 18, 2003.

(51) Int. Cl. G06F 17/60

(52) U.S. Cl. 705/7

(57) ABSTRACT

A business method of creating a sales team for processing invitations to tender and for performing the whole sales process has an enlarged sales team having at least one person in each functionary group including the sales manager, the tender engineer, and commercial and technical personnel, such as the product manager, project engineer, process technology manager and process engineer. In the method, a database is created with data from the sales team and the database is used to communicate items of delivery between the sales team and product development personnel. The database is further used to compare the invitation to tender with the technology files and identify the variations from the standard products, determine special features and development needs, and offer new information, and the solutions generated, to the customer.

### CROSS REFERENCES TO RELATED APPLICATIONS

This application claims priority on U.S. provisional Application No. 60/455,726, filed Mar. 18, 2003, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The present invention relates to methods for enhancing a sales process in papermaking machine business.

In this application referring to papermaking machines refers to any systems and devices relating to papermaking, such as systems and devices for production of pulp, paper, tissue and cardboard, as well as finishing and converting systems and automation systems for papermaking.

Selling papermaking machines is a relatively complicated process. It typically results in designing a customized papermaking system depending on the parameters and needs specified by the customer. Examples of adjustable parameters are machine speed, paper grades and machine width. The purchase may be a complete papermaking system for a new paper mill or an upgrade part for an existing mill.

The sales process typically starts with an invitation to tender, which is received by the papermaking machine supplier. The person starting first preparing the tender is the tender engineer and/or sales manager of the papermaking machine supplier having good knowledge of the sales process and papermaking machines in general. However, he is typically not well acquainted with the latest features and developments of the product development. The tender engineer makes the offer based on the technology files comprising the relevant data relating to the sale of the papermaking machines. These technology files have been prepared e.g. by the sales department or the sales support department and they are updated more or less regularly but typically they are not completely up-to-date with the product development.

The offer prepared by the tender engineer for the potential customer comprises information about the compilation of the system, a preliminary or binding price, timetable for the delivery and installation and optionally terms for penalty if the timetable is not met. Also other relevant terms may be included in the offer, such as guarantees for process and mechanics.

FIG. 1 illustrates in more detail the prior art method of selling the papermaking machines. The one-way and the two-way line arrows show the communication in various phases of the sales process between the parties in the sales process. The wide arrows show the material paths through which the actual papermaking machine components are transferred.

In step 1 the invitation to tender prepared by the customer is received at the papermaking machine supplier. It is first handled by the tender engineer who processes it and, usually together with the sales manager, makes a decision to tender in step 2. After the decision to tender has been made the preparation of the tender starts in step 3.

Preparation of the tender includes taking in consideration the conditions set by the customer and the technical parameters affecting the composition of the system under consideration. The tender engineer uses the technology files and his/her best knowledge to decide the optimal composition of the system to be delivered. After that he calculates the price of the system by using price lists of the components selected to the delivery.

Then the tender is sent to the customer and the actual sales negotiations between the customer and the papermaking machine supplier may start in step 4. In the sales negotiations all the relevant terms are settled, such as the timetable of the delivery, the possible fee for exceeding the timetable, etc.

When the agreement has been made in step 5, the technical preparation of the delivery starts in step 6. Technical preparation includes taking into consideration the technical parameters, such as machine speed, selection of paper grades required by the customer, and the machine width. Other relevant parameters may include e.g. running mode, linear load, steaming, and roll temperature. Technical preparations also include contacting the suppliers and the sub-suppliers for ordering the necessary components for the system to be delivered. Also the product development is contacted for designing any new features recognized and needed in the delivery and also consulted for the technical feasibility of the delivery.

Step 7 comprises the actual manufacturing of the system to be delivered. The components needed in the system are manufactured or received from the suppliers and sub-suppliers and the whole system is then assembled, tested and packed for transportation in the papermaking machine production plant.

Step 8 is the final step of the sales process comprising transporting the delivery to the customer.

The main problem with the prior art method of preparing an offer is that the tender engineer does not have enough information of the current status of all the systems that the papermaking machine supplier is able to deliver. Especially this is the problem with the technical feasibility of the purchasable system. The tender engineer and the sales manager are not able to identify and estimate accurately enough all the technical details of the system or deal with all the needs raised by the customer.

Therefore it is an object of the present invention to extend the sales team to overcome the problems with the prior art.

### SUMMARY OF THE INVENTION

The business method of this invention is to create a novel sales team for processing the upcoming invitations to tender and for performing the whole sales process. The enlarged sales team according to the invention comprises at least one person in each functionary group consisting of the sales manager, the tender engineer, and commercial and technical personnel, such as the product manager, project engineer, process technology manager and process engineer. In this team according to the invention the tender engineer and the sales manager are experts in creating a formal offer. The product manager and the project engineer have knowledge of the latest features of the product and the current status of the product development as well as the aims and potentials of the product development. The process engineer and the process technology manager have a thorough expertise of the whole papermaking process and the potentials and latest achievements of the process development.

It is an object of the present invention to provide a method of selling a papermaking machine, which allows the machine manufacturer to define more accurately the cost of the products and more cost-effectively sell its products.

It is also an object of the present invention to achieve a more accurate analysis of the invitation to tender and other arising customer needs, to evaluate more thoroughly the technical and commercial feasibility of the order as well as the timetable of the delivery and the upcoming costs.

Further objects, features and advantages of the invention will be apparent from the following detailed description when taken in conjunction with the accompanying drawings.

### BRIEF DESCRIPTION OF THE DRAWINGS

FIG. 1 illustrates a prior art method of selling papermaking machines.

FIG. 2 illustrates the method of selling papermaking machines according to the invention.

### DESCRIPTION OF THE PREFERRED EMBODIMENTS

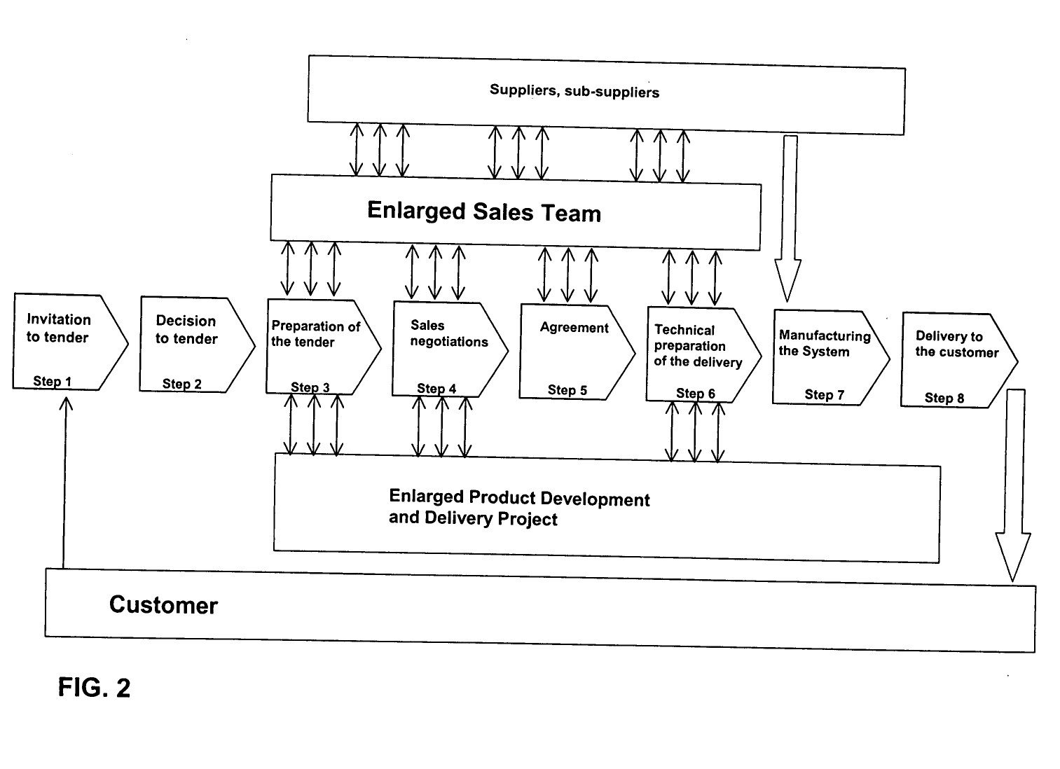

FIG. 2 illustrates the method of selling the papermaking machines according to the invention. The one-way and the two-way line arrows show the communication in various phases of the sales process between the parties in the sales process. The wide arrows show the material paths through which the actual papermaking machine components are transferred.

According to the invention the tender engineer does not take care of the sales process alone but the enlarged sales team is called in. The enlarged sales team is composed of persons with expertise in papermaking processes, in product development technology and in production and installation. Typically the tender engineer and the sales manager make the decision to tender but it is also possible to consult the enlarged sales team already at this step (step 2).

With its expertise the enlarged sales team analyzes the invitation to tender and identifies any implied customer needs. This analysis detects any needs for the product development as well as needs to design any non-standard components or systems for the delivery. If these needs appear, the required product development project or engineering effort may start immediately or at least in a much earlier stage than in the prior art method. Therefore in the method according to the invention the product development or engineering effort may be contacted already in step 3 for a preliminary product development project. The tender to be prepared according to the invention consists of a much more accurately defined plan for the delivery and more accurate price and timetable determination.

In step 4 according to the invention the sales negotiations are performed. The expertise of the enlarged sales team as well as the product development may be consulted when necessary in this step.

The agreement on the delivery is made in step 5. The enlarged sales team is consulted or if needed participates in the agreement stage.

In step 6 the technical preparation of the delivery is made. Compared to the prior art method, in the method according to the invention the technical preparation is in a much more advanced state because of the relevant information received in steps 3 and 4.

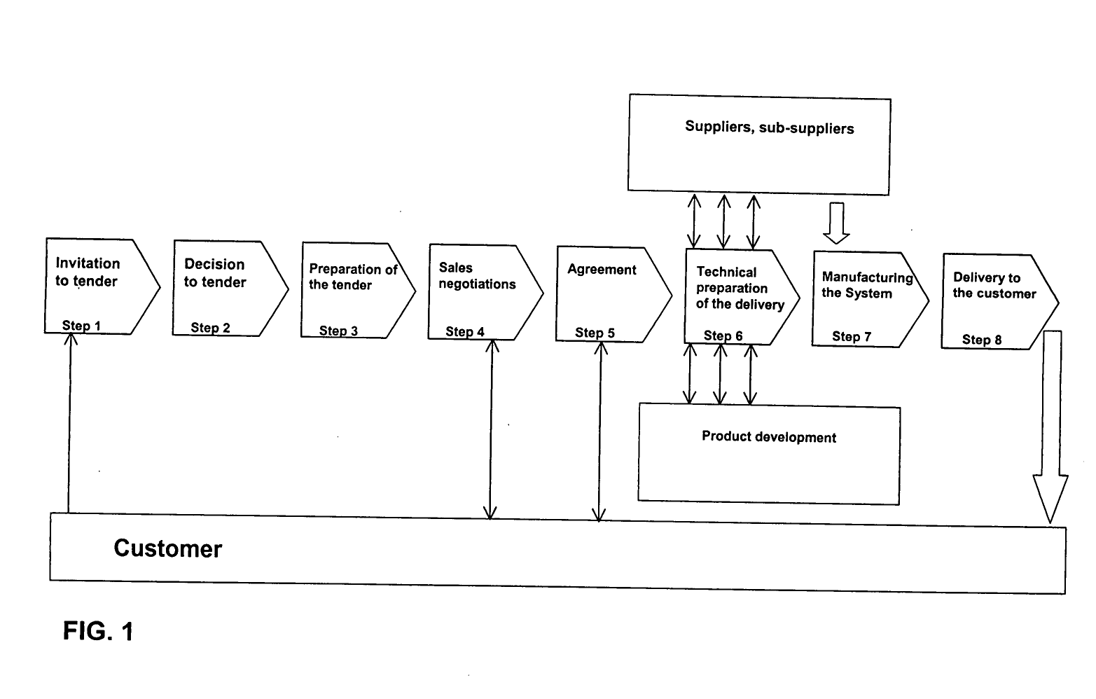

Steps 7 and 8 comprise the same functions as was described in connection with FIG. 1. However, due to the concurrent engineering processes and methods applied in prior steps, manufacturing of the delivered system may start earlier than in the prior art method. Also, manufacturing is better planned according to the invention and this shortens the time used for the actual manufacturing.

The present invention makes it possible to optimize the profit margin and at the same time to offer products to the customer with reasonable price. Therefore using the method according to the invention the papermaking machine supplier can reach better profit through better targeted and performed sales process, process expertise and delivery optimizations.

According to the invention the sales team receives information more effectively and the information is more accurate and relevant for the sales process. Therefore the main benefits of the invention are a more specified tender, a more accurately defined price, and a more accurately defined technical feasibility. Also a more accurately planned timetable for the delivery is a benefit to the customer as well as to the supplier.

The information produced by the enlarged sales team is input in to databases and further processed in the information systems of the papermaking machine provider. The databases, which are common to all parties of the enlarged sales team, comprise i.e. the pricing database consisting of the price lists and other data related to pricing, and the sales project's database consisting of the relevant data for the sales process. These databases are structured so that data e.g. the initial data, technical specifications, and economical calculations are preferably grouped into their own entities for easy accessibility. Using said databases the different parties of the sales event may utilize, analyze and process information for their own needs. The databases are flexibly accessible by the said users in various locations utilizing the local network through wired or wireless connections.

When making the decision to tender and preparing the tender, the different parties of the enlarged sales team input their own contribution to the database in the following manner. The technical experts define and select the technical features, such as number of rolls, roll materials, mechanical solutions, automation solutions, and process technology solutions such as required roll temperature, linear load and steaming, and input this data to the database. Then using the information input in the databases the technical experts compare the invitation to tender with the technology files and identify the variations from the standard products, special features and development needs.

According to the invention new information and novel solutions generated during the operation of the enlarged sales team and/or during development projects may be offered to the customer.

In the following the patent claims will be given and various details of the invention may show variation within the scope of the inventive idea defined in the patent claims and differ from the details disclosed above for the sake of example only.

I claim:

1. A method for enhancing a sales process of papermaking machines or papermaking machine units or upgrades comprising the steps of:
in responding to an invitation to tender received from a customer, setting up a sales team comprised of a tender engineer, a sales manager, a person with expertise in papermaking processes, a person with expertise in product development, and a person with expertise in production;
analyzing said invitation to tender by inputting into a database, data from the sales team comprising at least: data from the invitation to tender, technology files, pricing data, and technical specifications including technical features and process technology solutions;
generating from the database the economic calculations to determine costs of variations from standard products;
using the database to communicate items of delivery between the sales team and product development personnel;
using the information input in the databases from the sales team to compare the invitation to tender with the technology files and identify the variations from the standard products, determine special features or development needs;
using the database to make decisions on what to offer the customer; and
offering new information, and solutions, generated by the sales team using the database, to the customer.

2. The method of claim 1 wherein the technical features include the number of rolls, roll materials, mechanical solutions, and automation solutions.

3. The method of claim 1 wherein the process technology solutions include roll temperature, linear load and steaming,

4. The method of claim 1 wherein the sales team further comprises persons with the expertise in installation of papermaking machines or papermaking machine units or upgrades to a papermaking machine.

5. The method of claim 1 wherein the step of using the information input in the databases comprises identifying implied customer need for non-standard components or systems.

6. The method of claim 1 wherein the step of communicating items of delivery between the sales team and product development comprises negotiations between the sales team and the product development personnel.

7. The method of claim 1 wherein the method further comprises starting a product development process for the future delivery during the preparation of the tender before reaching agreement for deliverables with the customer.

8. A method of selling papermaking machines or papermaking machine units or upgrades to a papermaking machine comprising the steps of:
responding to an invitation to tender received from a customer by:
setting up a sales team comprised of a tender engineer, a sales manager, a person with expertise in papermaking processes, a person with expertise in product development, and a person with expertise in production;
making a decision to tender based on input from at least the tender engineer, and the sales manager;
inputting into a database data from the sales team comprising at least data from the invitation to tender, technology files, pricing data, technical specifications including technical features and process technology solutions, wherein the data is structured in separate entities for initial data, technical specifications, and economic calculations;
generating from the database the economic calculations to determine costs of variations from standard products;
using the database to communicate items of delivery between the sales team and product development personnel;
using the information input in the databases from the sales team to compare the invitation to tender with the technology files and identify the variations from the standard products, determine special features and development needs; and
offering new information and solutions, generated by the sales team using the database, to the customer.

9. The method of claim 8 wherein the technical features include the number of rolls, roll materials, mechanical solutions, and automation solutions.

10. The method of claim 8 wherein the process technology solutions include roll temperature, linear load and steaming,

11. The method of claim 8 wherein the sales team further comprises persons with expertise in installation of papermaking machines or papermaking machine units or upgrades to a papermaking machine.

12. The method of claim 8 wherein the step of using the information input in the databases comprises identifying implied customer need for non-standard components or systems.

13. The method of claim 8 wherein the step of communicating items of delivery between the sales team and product development comprises negotiations between the sales team and the product development personnel.

14. The method of claim 8 wherein the method further comprises starting a product development process for the future delivery during the preparation of the tender before reaching agreement for deliverables with the customer.
